(19) United States
(12) Patent Application Publication
(10) Pub. No.: US 2019/0106170 A1
(43) Pub. Date: Apr. 11, 2019

(54) BIKE LOCK

(71) Applicants: Wyatt Sven HAGEN, Santa Barbara, CA (US); Jonah Light IWANAGA, Santa Barbara, CA (US)

(72) Inventors: Wyatt Sven HAGEN, Santa Barbara, CA (US); Jonah Light IWANAGA, Santa Barbara, CA (US)

(21) Appl. No.: 16/155,188

(22) Filed: Oct. 9, 2018

Related U.S. Application Data
(60) Provisional application No. 62/571,226, filed on Oct. 11, 2017.

(51) Int. Cl. B62H 5/00; E05B 71/00; E05B 67/00

(52) U.S. Cl. CPC B62H 5/003; E05B 73/0005; E05B 67/003; E05B 71/00

(57) ABSTRACT

A bike lock has an outer bar, an inner bar having a portion slidably received within the outer bar so as to move between a retracted position and an extended position, and a locking mechanism cooperative with the outer bar and the inner bar so as to lock the inner bar in the extended position. The outer bar is a tubular member that has an interior passageway. The inner bar is received in the interior passageway. The outer bar in the inner bar have a circular configuration when in the fully extended position. A latching mechanism is cooperative with the outer bar and the inner bar so as to retain the inner bar in the retracted position.

### CROSS-REFERENCE TO RELATED APPLICATIONS

The present application claims priority from U.S. Provisional Patent Application Ser. No. 62/571,226, filed on Oct. 11, 2017, and entitled “Bike Lock”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to locks for bicycles and other wheeled vehicles.

### 2. Description of Related Art Including Information Disclosed Under 37 CFR 1.97 and 37 CFR 1.98.

A bike lock is a security device used to deter bicycle theft generally by fastening the bicycle to a fixed object, such as a bike rack. Quick-release levers, common on most bicycle wheels and seatpost fasteners, are a major challenge for theft prevention. Unless both wheels in the frame are secured, wheels can be removed separately. An optimal locking method secures the frame, as well as both wheels, to either a fixed object or to each other. Locking devices vary in size and security. The most secure tend to be the largest, heaviest and least portable. Thus, like other security equipment, bike locks must balance the competing interests of security, portability and cost.

Currently, in the bike lock market, the “U-lock” is the dominant product on the market. U-locks are typically made up of two separate and distinct pieces, a steel bar in the shape of a “U” and a locking piece that couples to the “U” and allows one to lock it. Most U-locks use keyed lock mechanisms. U-locks can be cumbersome often make the user feel like they need three hands for proper operation due to the two separate pieces that need to be held together, along with the key to lock the two pieces together. To lock the bicycle, one locks it physically to some other object, such as a bike rack, parking meter, or other pole installed securely in solid ground. U-locks are more secure than most other kinds of locking mechanisms because they are more resistant to cutting with high-leverage hand tools, such as bolt cutters.

These U-locks are often very difficult to manipulate. Typically, when one is using the U-lock, the user places one component generally adjacent their leg or knee and then manipulates the U-piece and the locking piece. The user must then manipulate a combination lock or a key lock in order to properly secure the locking piece to the U-piece. This can result in a great deal of frustration during the locking process. Under certain circumstances, the difficulty of achieving this locking can lead one to occasionally neglect to lock the bicycle which, in turn, can lead to theft. Under many circumstances, these U-locks take up a significant amount of space when being transported on the bicycle. Under other circumstances, since the U-lock is at least a two-piece construction, one of the pieces can be left behind or lost so as to make the U-lock impossible to secure together. As such, a need has developed so as to provide a proper bike lock which allows the user to easily lock the bicycle while making it impossible to separate or lose separate pieces of the lock.

In the past, various patents have issued with respect to bike locks. For example, U.S. Pat. No. 3,824,540, issued on Jul. 16, 1974 to K. R. Smith, describes a bicycle lock and alarm apparatus for use as a preventive or deterrent device and controlling bicycle thievery. A continuous cable is adapted to extend through the bicycle wheels and also about the bicycle frame to a mobile lock to immobilize the wheels and join the ends of the cable to form a loop.

U.S. Pat. No. 3,950,972, issued on Apr. 20, 1976 to Bleier et al., teaches a bicycle lock which is adapted for fixedly mounting on the bicycle. The bicycle lock includes a housing, which has a shackle receptacle rotatably mounted therein. An elongated flexible shackle has one end fixed to the shackle receptacle and the other releasably connectable to the housing. The flexible shackle is windable upon the shackle receptacle for storage in the housing. A ratchet wheel is fixed to the shackle receptacle for rotation therewith. A lock pin is connected to the other end of the flexible shackle and is positionable in the housing. The lock pin has a dog, which is engageable with the ratchet wheel, to limit rotation of the ratchet wheel and the shackle receptacle to one direction for winding the flexible shackle into the receptacle.

U.S. Pat. No. 4,033,160, issued on Jul. 5, 1977 to J. J. Mima, describes a bicycle lock that includes a housing structure secured to the frame of the bicycle under the seat adjacent the rear bicycle wheel. A C-shaped member is pivoted to the housing structure for movement from an unlocked position to a locked position wherein the member passes under the rear tire and rim portion of the wheel. The housing includes a spring-loaded cable with one end exposed which can be pulled from the housing and the looped about the stationary object, such as a post, and then re-inserted through an entrance opening in a side of the housing so that the wheel of the bicycle is not only locked against rotation, but the bicycle itself is secured to a stationary object. A single cylinder tumbler type key-operated lock functions to simultaneously release the C-shaped member from its locked position and the one end of the cable from the entrance opening.

U.S. Pat. No. 4,055,060, issued Oct. 25, 1977 to J. Beloino, provides a bicycle lock wherein the steering is locked and a securing cable is provided the fasten the bike to a fixed object. The lock is provided with a removable tumbler, having an axially aligned pin, that normally passes through an eyelet on one end of the cable and through suitable bores, in the steering post and the rotatable steering sleeve, respectively.

U.S. Pat. No. 5,010,374, issued on May 28, 1991 to V. J. Montano, teaches a bicycle lock having a two-way horizontal swivel bicycle frame clamp which is secured by a nut and bolt to the bicycle frame. The clamp wraps around the bicycle frame just below the seat post and is secured in place by the nut and bolt. The lock also includes a 90° pivot rod, one end of which is connected to the clamp and acts as a hinge so as to allow the unit to move back and forth in the horizontal direction. A two-way cylinder is attached to the pivot rod so as to permit the unit to move back and forth in a vertical direction similar to the movement of a hinge. There also flat metal tracks such that one end of one track is attached to the cylinder and the other end is connected to the other tracks, one after another in line, and held together by rivets.

U.S. Pat. No. 5,647,520, issued on Jul. 15, 1997 to C. McDaid, shows a bicycle lock bracket for use with a lock that has an elongated portion with a free end when the lock is open. The bracket includes at least one spline on the elongated portion of a body fastened to the bicycle frame. The spline is either integral with the elongated portion or is on a collar affixed to the elongated portion. The body includes a hub with an opening for receiving the elongated portion. At least one groove in the inner wall of the opening mates with the spline. The elongated portion is prevented from traveling completely through the opening by a shoulder on the collar or a stop at the end of at least one groove. The body includes a seat for fastening the body to the bicycle frame.

U.S. Pat. No. 7,823,424, issued on Nov. 2, 2010 to Shabtay et al., discloses a bicycle lock in the form of a cable lock that includes an elongated lock body and a cable having first and second ends. The first end is fixed to one end of the elongated lock body and another end of the lock body has an insertion opening for an insertion pin that is attached to the second end of the cable and is provided with two lateral, diametrically-opposed recesses that are oriented parallel to the longitudinal direction of the lock body. Two locking bolts are insertable into the recesses in a translatory manner in the longitudinal direction of the lock body for securing the insertion pin in the lock body. A driver, which lies with inner ends in an effective area of the drive, is rotatable by means of a closing cylinder. By actuation of the closing cylinder, the locking device is drivable in the longitudinal direction of the lock body.

U.S. Pat. No. 8,505,342, issued on Aug. 13, 2013 to K. Taiga, describes a bicycle lock structure with a dual latch. This bicycle lock structure includes a latch seat and a lock body. The two parallel latches are set on one side of the latch seat. Two inserting holes are set on one side of the lock body for inserting the latches. There is a bead that wedges into a wedged hole of the latch by a slider inside the lock body so as to provide wedged locking.

U.S. Patent Application Publication No. 2002/0170324, published on Nov. 21, 2002 to J. H. Wilson, teaches a bicycle lock device with a housing holding an extensible and retractable cable on a spring-biased reel. The bias spring for the reel is substantially sealed. The interior of the housing is open to the outside at only one opening through which the cable passes. The cable may be pulled out from the housing to position its outer end between laterally spaced, outwardly projecting ears on the outside of the housing. An opening at the outer end of the cable registers with openings in these ears for the attachment of a padlock.

U.S. Patent Application Publication No. 2017/0069154, published a Mar. 9, 2017 to Hilton et al., provides a modular bike lock which includes a locking mechanism and a securing mechanism coupled to the locking mechanism. The securing mechanism wraps around at least a portion of the bicycle and includes a locking and configured to engage with the locking mechanism to lock the bike lock.

U.S. Patent Application Publication No. 2017/0292295, published on Oct. 12, 2017 to J. Alvarado, teaches a bike lock that has a lock body and a set of arms. The lock body is mountable on the seat of the bicycle. The arms extend from the lock body and terminate in locking surfaces. The locking surfaces are secured together by a locking element. The locking body and arms comprise an integrated textile fabric and steel cable structure simultaneously resistant to sawing and slicing. The lock body secures the bicycle seat while the arms are threaded through and around bicycle components to attach to a stationary object.

It is an object of the present invention to provide a bike lock that is readily operated using two hands.

It is another object of the present invention to provide a bike lock that can be stored compactly when not in use.

It is another object of the present invention to provide a bike lock that can be placed into a locking configuration with minimal effort.

It is another object of the present invention to provide a bike lock that is easily transportable.

It is another object of the present invention to provide a bike lock that has minimal components.

It is another object of the present invention provide a bike lock that can be easily unlocked and returned to a stowage position.

It is another object of the present invention provide a bike lock that is aesthetically pleasing.

It is another object the present invention to provide a bike lock that is lightweight.

It is another object of the present invention to provide a bike lock that has reduced manufacturing costs.

It is a further object of the present invention to provide a bike lock that eliminates the need to physically hold separate components.

It is still another object of the present invention to provide a bike lock that has a circular locking motion.

It is a further object the present invention to provide a bike lock that has a locking motion that prevents relative motion between the outer bar and the inner bar.

These and other objects and advantages of the present invention will become apparent from a reading of the attached specification and appended claims.

### BRIEF SUMMARY OF THE INVENTION

As used herein, the term “bike” refers to bicycle, tricycles, motorcycles, carriages, and similar items. As such, is contemplated, within the present invention, that the bike lock of the present invention can be used not only with bicycles, but with a wide variety of other items.

The bike lock of the present invention comprises an outer bar, an inner bar having a portion slidably received within the outer bar so as to move between a retracted position and an extended position, and a locking mechanism cooperative with the outer bar and the inner bar so as to lock the inner bar in the extended position.

The outer bar is a tubular member that has an interior passageway. The inner bar is received in this interior passageway. The inner bar will have a length that is greater than a length of a chord between opposite ends of the outer bar. The outer bar and the inner bar have a circular configuration when in the extended position. The outer bar and the inner bar can each have a round or a square cross-section.

A latching mechanism is cooperative with the outer bar and the inner bar so as to retain the inner bar in the retracted position. The inner bar has a notch formed adjacent one end thereof The latching mechanism engages the notch when the inner bar is in the retracted position. In particular, the latching mechanism includes an arm pivotally mounted to the outer bar. The arm has at least a portion accessible from an exterior of the outer bar. The arm has a latch at one end thereof. This latch is engageable with the notch of the inner bar when the inner bar is in the retracted position. The arm is mounted in a channel of the outer bar so as to be movable between a latching position and a release position. The latch engages the notch of the inner bar in the latching position. The release mechanism allows the inner bar to move toward the extended position.

The locking mechanism engages the notch when the inner bar is in the extended position. The locking mechanism includes a split ring positioned interior of the outer bar adjacent one end thereof. The split ring is engageable with the notch of the inner bar when the inner bar is in the fully extended position. An actuator is cooperative with the split ring. The actuator is movable between a first position and a second position. The first position causes of the split ring to open so as to allow the notch of the inner bar to enter an interior of the split ring. The second position causes the split ring to close and to be received in the notch so as to lock the one end of the inner bar within the one end of the outer bar. The locking mechanism further includes a key and a cylinder having a keyway therein. The keyway receives the key therein. The cylinder is cooperative with the actuator so as to cause the actuator to move between a first position and a second position. The split ring is mounted within an annular channel interior of the outer bar adjacent one end of the outer bar. The split ring has a split formed at one side thereof The actuator has a tapered member that is engageable with the split ring so as to open the split ring when the actuator is in the first position. The split ring is resiliently mounted within the channel so as to urge the split ring to the first position. One end of the inner bar is tapered so as to urge the split ring toward the second position as one end of the inner bar enters the end of the outer bar.

A spring is mounted in an interior of the outer bar and is cooperative with the inner bar so as to urge the inner bar toward the extended position. As such, when the latch is released, the inner bar will move outwardly from the retraced position.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective view showing the bike lock of the present invention in which the inner bar is in the fully extended position.

FIG. 2 is a perspective view of the bike lock of the present invention with the inner bar in the retracted position.

FIG. 3 is an upper perspective view of the bike lock of the present invention showing the inner bar as emerging from one end of the outer bar.

FIG. 4 is a transparent view of one end of the outer bar showing the end of the inner bar as approaching the locking mechanism of the outer bar.

FIG. 5 shows a transparent perspective view of a further step in the locking of the end of the inner bar within the end of the outer bar.

FIG. 6 is a transparent perspective view of the end of the outer bar and showing, in particular, the operation of the locking mechanism.

FIG. 7 is a transparent perspective view of the locking mechanism of the present invention as releasing the end of the inner bar.

### DETAILED DESCRIPTION OF THE INVENTION

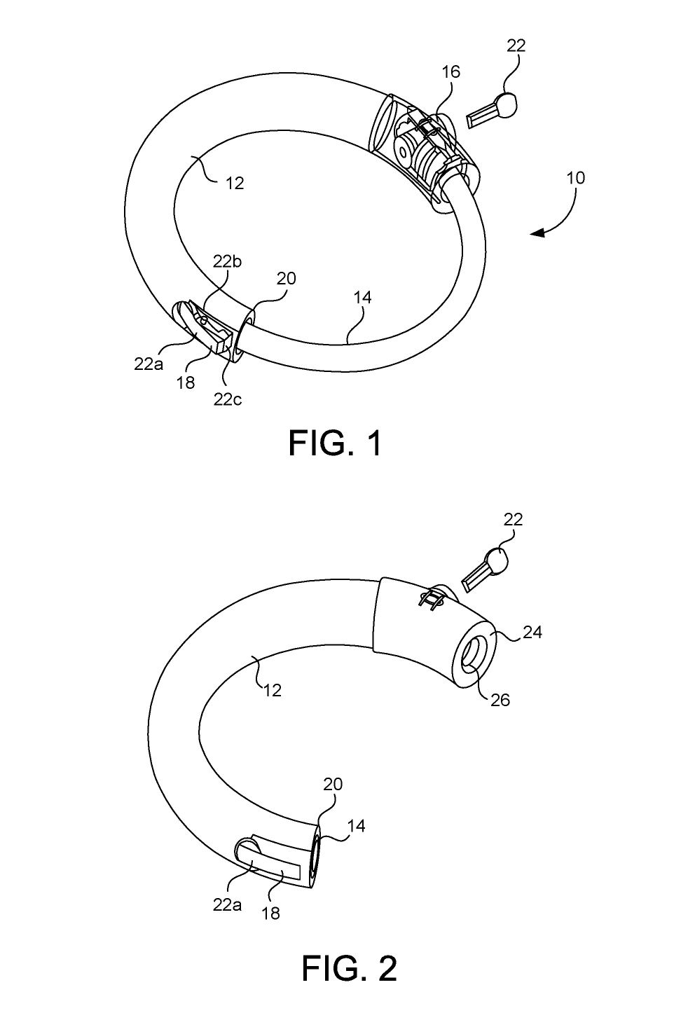

Referring to FIG. 1, there is shown the bike lock 10 in accordance with the preferred embodiment of the present invention. The bike lock 10 includes an outer bar 12, an inner bar 14 and a locking mechanism 16. There is a latching mechanism 18 positioned adjacent to an end 20 of the outer bar 12. The inner bar 14 is slidably received within an interior passageway of the outer bar 12. The inner bar 14 will have a length that is greater than a chord between ends of the outer bar 12. In FIG. 1, can be seen that the inner bar 14 is in its extended position so that an end of the inner bar 14 is received by the locking mechanism 16 and locked in position so as to form a circular configuration.

The outer bar 12 is a tubular member and the inner bar 14 is a solid member of either a round or square cross-section. Each of the outer bar 12 in the inner bar 14 can be formed of a high-strength material, such as steel. Since the inner bar 14 has a length greater than the length of the interior passageway of the outer bar 12, it will be inherently retained within the outer bar 14 when in the extended position. FIG. 1 shows that there is a key 22 that is insertable into a keyway of a cylinder associated with the locking mechanism 16. The key 22 can be turned to one position to unlock the locking mechanism 16 so as to allow the inner bar 14 to return to the retracted position and turned the other way so as to lock the end of the inner bar 14 within the end of the outer bar 12 and within the locking mechanism 16. The latching mechanism 18 will retain the end of the inner bar 14 in the retracted position within the interior passageway of the outer bar 12.

The latching mechanism 14 includes an arm 22a which has a surface exposed at the exterior of the outer bar 14. In particular, the arm 22a is received within a channel 20 formed through the thickness of the wall of the outer bar 12. There is a latch 22c that extends inwardly from the end of the arm 22a that is engageable with the notch of the inner bar 14.

FIG. 2 shows the inner bar 14 in its retracted position within the end 20 of the outer bar 12. In this position, the latching mechanism 18 is closed so as to engage with a notch (not shown) at the end of the inner bar 14. The end 24 of the outer bar 12 has an opening 26 into which the end of the inner bar 14 is received.

In FIG. 2, it can be seen that the arm 22a of the latching mechanism 18 is closed so as to be generally flush with the exterior surface of the outer bar 12. As such, the latch 22c will engage with the notch at the end of the inner bar 14 so as to retain the inner bar 14 in its retracted position.

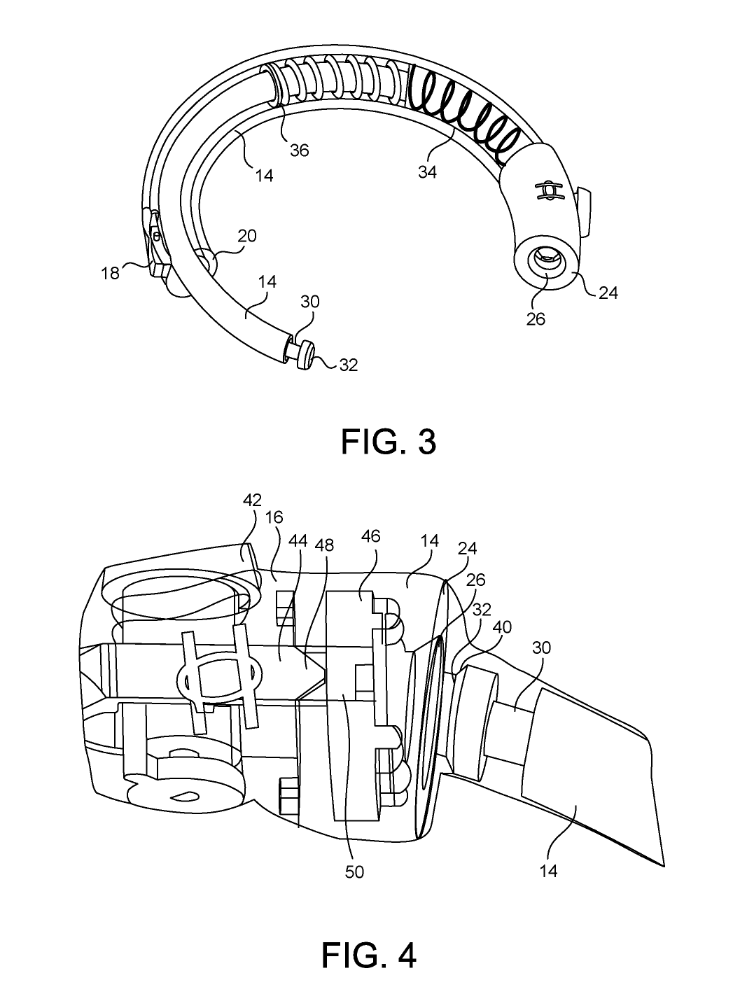

FIG. 3 shows the inner bar 14 as emerging from the end 20 of the outer bar 14. The latching mechanism 18 has been depressed so as to cause the latch 22a to separate from its engagement with the notch 30 adjacent to the end 32 of the inner bar 14. In FIG. 3, a spring 34 is positioned within the interior of the outer bar 14. Spring 34 bears on a shoulder 36 of the inner bar 14 so as to urge the inner bar 14 to move outwardly from its retained position (shown in FIG. 2) within the outer bar 14. However, within the concept of the present invention, the spring 34 can also be configured so as to bear against an end of the inner bar 14 opposite the end 32. Spring 34 will urge the inner bar 14 outwardly so that it can be easily grasped by a user so as to be moved from the retracted position to the extended position which is received within the opening 26 at the ends 24 of the outer bar 14.

FIG. 4 shows a detailed view of the notch 30 and the end 32 of the inner bar 14 as it approaches the opening 26 at the end 24 of the outer bar 14. In particular, there is a tapered surface 40 formed at end 32.

The locking mechanism 16 is positioned adjacent to the end 24 of the outer bar 14. It can be seen that the locking mechanism 16 includes a cylinder 42 having a keyway therein and an actuator 44. A split ring 46 is located within an annular channel on the interior of the outer bar 14 adjacent to the end 24. As the tapered surface 40 at the end 32 of the inner bar 14 enters the opening 26 and enters the interior of the split ring 46, it will cause the split ring 46 to open so that the notch 34 will be located within the interior of the split ring 46. The actuator 44 has a tapered member 48 at an end thereof. Tapered member 48 will engage with the V-shaped area 50 of the split ring 46 so as to allow the split ring 46 to open and close. The split ring 46 is resiliently mounted within the channel so as to be urged toward the closed position.

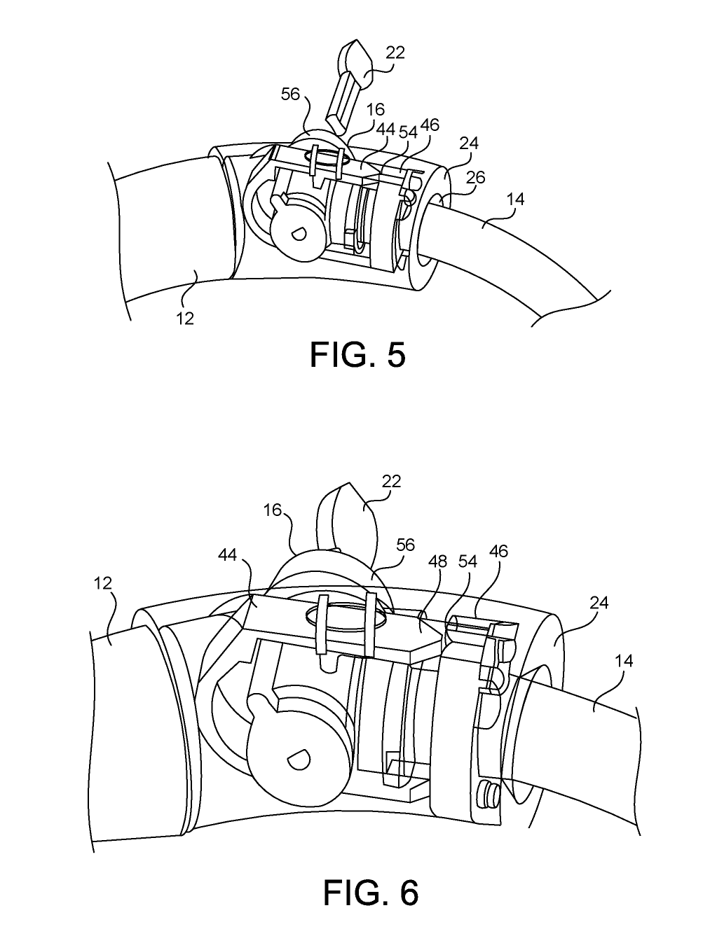

FIG. 5 shows that the inner bar 14 is received within the opening 26 at the end 24 of the outer bar 12. In this configuration, the split ring 46 is closed around the notch 30. As such, the end of the inner bar 14 is securely locked within the end 28 of the outer bar 12. The actuator 44 is shown as spaced away from a V-shape area 54 on the split ring 46. Since the split ring 46 is resiliently mounted within the outer bar 12, it will automatically close around the notch 36 when the end 32 of the inner bar 14 is fully inserted into the end 24 of the outer bar 12. Key 22 is illustrated as approaching the cylinder 56 of the locking mechanism 16. In the present invention, a user can easily and automatically lock the inner bar 14 in its extended position so as to be engaged with the outer bar 12 by simply pushing the end of the inner bar 14 into the area of the split ring 46. As such, the end of the inner bar 14 will open the split ring 46 automatically and the split ring 46 will close automatically once the notch 30 enters the interior of the split ring. The key 26 is only required so as to unlock the locking mechanism 16 so as to allow the end of the inner bar 14 to be released from the split ring 46.

FIG. 6 shows an initial step in the unlocking of the end of the inner bar 14 from its position in engagement with the split ring 46 adjacent to the end 24 of the outer bar for 12. FIG. 6 also shows the configuration of the actuator 44. The actuator 44 is a generally U-shaped member that is cooperative with the cylinder 56 of the locking mechanism 16. As such, the actuator 44 will move with the rotation of the cylinder 16 caused by the turning of the key 22. The actuator 44 has tapered member 48 at an end thereof. Tapered member 48 faces the V-shaped area 54 formed between separate sides of the split ring 46.

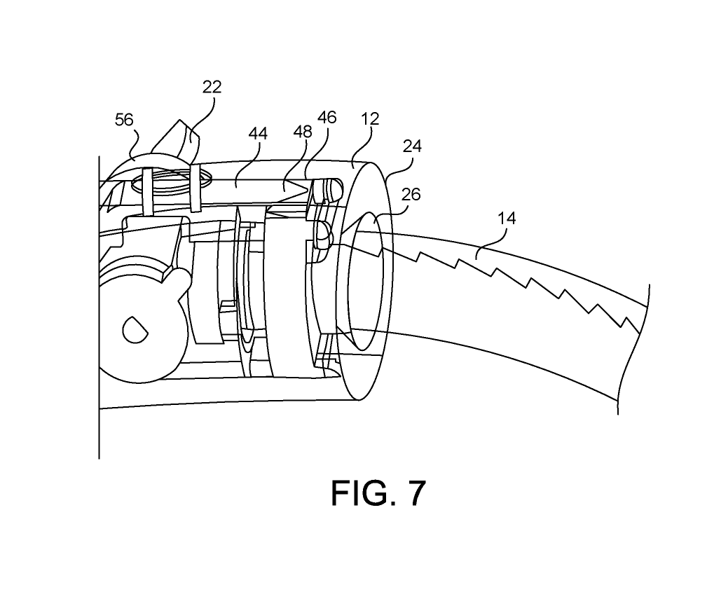

FIG. 7 shows a further step in the unlocking of the inner bar 14 with respect to the outer bar 12. As can be seen, the tapered member 48 of the actuator 44 has moved forwardly as a result of the turning of the key 22 within the cylinder 56. The actuator 44 is suitably rotated so that the tapered member 48 moves forwardly toward the V-shaped area 54 of the split ring 46. This movement causes the ends of the split ring 46 to separate so as to open the split ring 46. This opening releases the notch 30 of the inner bar 14 from its engagement within the interior of the outer bar 12. As such, the inner bar 14 can easily be pulled outwardly from the opening 26 at the end 24 of the outer bar 12. The user can then manually moved the inner bar 14 back to its retracted position within the outer bar 14 (as shown in FIG. 2). The latch mechanism 18 can then be closed so that the latch engages with the notch 30 so as to retain the inner bar 14 in its retracted position.

The present invention, by its simple construction, can be readily operated by using two hands. All that is necessary to lock the bike lock 10 to the bike only requires a manipulation of the latch mechanism 18 so as to release the inner bar 14 from its retracted position. A user can then use one hand to grab the outer bar 12 and use the other hand to manipulate the inner bar 14 so as to move the inner bar 14 toward the end 24 of the outer bar 14. The user then simply moves the inner bar 14 until it is engaged with the split ring 46 of the locking mechanism 16. The locking is then achieved. There is no need to use the key during this procedure. Once the bicycle is locked, the key 22 can then be inserted into the keyway of the cylinder 46 and rotated so that the split ring 46 releases the end of the inner bar 14. The user can then use one hand to simply move the inner bar 14 back to its retracted position in which the notch 30 is automatically engaged with the latching mechanism.

In the retracted position, the bike lock 10 of the present invention has an extremely compact configuration. As such, it can be easily stored and transported. Since there only two separate components of the present invention (i.e. the bike lock 10 and the key 22), it becomes very difficult to lose separate components. The inner bar 10 will inherently be retained within the interior passageway of the outer bar 14 since the inner bar 14 has a length greater than the length of the chord between the end 12 of the outer bar 14 and the end 24 of the outer bar 14.

The present invention also has an aesthetically pleasing configuration. When in the extended position, the bike lock 10 of the present invention presents a unique circular configuration. The bike lock 10 of the present invention is lightweight and has minimal manufacturing costs. The present invention has a locking motion that prevents relative motion between the outer bar and the inner bar.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

We claim:

1. A bike lock comprising:
an outer bar;
an inner bar having a portion slidably received within said outer bar, said inner bar slidable with respect to said outer bar so as to move between a retracted position and an extended position; and
a locking mechanism cooperative with said outer bar and said inner bar so as to lock said inner bar in the extended position.

2. The bike lock of claim 1, said outer bar being a tubular member that has an interior passageway, said inner bar received in said interior passageway, said inner bar having a length that is greater than a length of a chord between opposite ends of said outer bar.

3. The bike lock of claim 1, said outer bar and said inner bar having a circular configuration when in the fully extended position.

4. The bike lock of claim 1, further comprising:
a latching mechanism cooperative with said outer bar and said inner bar so as to retain said inner bar in the retracted position.

5. The bike lock of claim 4, said inner bar having a notch formed adjacent one end thereof, said latching mechanism engaging said notch when said inner bar is in the retracted position.

6. The bike lock of claim 5, said locking mechanism engaging said notch when said inner bar is in the extended position.

7. The bike lock of claim 1, said inner bar having a notch formed adjacent one end thereof, said locking mechanism comprising a split ring positioned interior of said outer bar adjacent one end thereof, said split ring engaging said notch of said inner bar when said inner bar is in the fully extended position.

8. The bike lock claim 7, said locking mechanism comprising:
an actuator cooperative with said split ring, said actuator movable between a first position and a second position, said first position causing said split ring to open so as to allow said notch of said inner bar to enter into an interior of said split ring, said second position causing said split ring to close and to be received in said notch so as to lock the one end of said inner bar within the one end of said outer bar.

9. The bike lock of claim 8, said locking mechanism further comprising:
a key; and
a cylinder having a keyway therein, said keyway receiving said key therein, said cylinder cooperative with said actuator so as to cause said actuator to move between the first position and the second position.

10. The bike lock of claim 8, said split ring being mounted within an annular channel interior of said outer bar adjacent the one end of said outer bar, said split ring having a split formed at one side thereof, said actuator having a tapered member that is engageable with said split ring so as to open said split ring when said actuator is in said first position.

11. The bike lock of claim 10, said split ring being resiliently mounted within said channel so as to urge said split ring to the first position.

12. The bike lock of claim 10, the one end of said inner bar being tapered so as to urge said split ring toward the second position as the one end of said inner bar enters the one end of said outer bar.

13. The bike lock of claim 5, said latching mechanism comprising:
an arm pivotally mounted on said outer bar, said arm having at least a portion accessible from an exterior of said outer bar, said arm having a latch at one end thereof, said latch engageable with the notch of said inner bar when said inner bar is in the retracted position.

14. The bike lock claim 13, said arm being mounted in a channel of said outer bar so as to be movable between a latching position and a release position, said latch engaging the notch of said inner bar in the latching position, the release position allowing said inner bar to move toward the extended position.

15. The bike lock of claim 1, further comprising:
a spring mounted in an interior of said outer bar and cooperative with said inner bar so as to urge said inner bar toward the extended position.

16. A bike lock comprising:
an outer bar;
an inner bar having a portion slidably received within said outer bar, said inner bar slidable with respect to said outer bar so as to move between a retracted position and an extended position;
a locking mechanism cooperative with said outer bar and said inner bar so as to lock said inner bar in the extended position; and
a latching mechanism cooperative with said outer bar and said inner bar so as to retain said inner bar in the retracted position.

17. The bike lock of claim 16, said inner bar having a notch formed adjacent one end thereof, said latching mechanism engaging said notch when said inner bar is in the retracted position.

18. The bike lock of claim 17, said latching mechanism comprising:
an arm pivotally mounted in said outer bar, said arm having at least a portion accessible from an exterior of said outer bar, said arm having a latch at one end thereof, said latch engageable with the notch of said inner bar when said inner bar is in the retracted position, said arm being mounted in a channel of said outer bar so as to be movable between a latching position and a release position, said latch engaging the notch of said inner bar in the latching position, the release position allowing said inner bar to move toward the extended position.

19. A bike lock comprising:
an outer bar;
an inner bar having a portion slidably received within said outer bar, said inner bar slidable with respect to said outer bar so as to move between a retracted position and an extended position; and
a locking mechanism cooperative with said outer bar and said inner bar so as to lock said inner bar in the extended position, said inner bar having a notch formed adjacent one end thereof, said locking mechanism comprising a split ring positioned interior of said outer bar adjacent one end thereof, said split ring engaging said notch of said inner bar when said inner bar is in the extended position.

20. The bike lock of claim 19, said locking mechanism comprising:
an actuator cooperative with said split ring, said actuator movable between a first position and a second position, said first position causing said split ring to open so as to allow said notch of said inner bar to enter an interior of said split ring, the second position causing said split ring to close and to be received in said notch so as to lock the one end of said inner bar within the one end of said outer bar;
a key; and
a cylinder having a keyway therein, said keyway receiving said key therein, said cylinder cooperative with said actuator so as to cause said actuator to move between the first position and the second position.
